(19) United States
(12) Patent Application Publication
(10) Pub. No.: US 2014/0310732 A1
(43) Pub. Date: Oct. 16, 2014

(54) DISK DRIVE APPARATUS

(71) Applicant: Sony Corporation, Tokyo (JP)

(72) Inventors: Naofumi Goto, Kanagawa (JP); Takeharu Takasawa, Kanagawa (JP); Takeshi Kubo, Kanagawa (JP)

(73) Assignee: Sony Corporation, Tokyo (JP)

(21) Appl. No.: 14/221,318

(22) Filed: Mar. 21, 2014

(30) Foreign Application Priority Data
Apr. 12, 2013 (JP) 2013-083949

(51) Int. Cl. G11B 17/028; G11B 17/03

(52) U.S. Cl. CPC G11B 17/0284; G11B 17/03
USPC 720/604

(57) ABSTRACT

There is provided a disk drive apparatus including a first chassis unit that has a first pickup base supported by the first base chassis through an elastically deformable insulator, and a second chassis unit that has a second pickup base supported by the second base chassis through an elastically deformable insulator. At least one of the first chassis unit and the second chassis unit is moved in a thickness direction of the disk-like recording medium, and the first pickup base and the second pickup base are connected to or separated from each other. Positioning parts for performing positioning of the first pickup base and the second pickup base at a time of connection are provided at the first pickup base and the second pickup base, respectively. The first pickup base and the second pickup base are connected to each other by magnetic forces of magnets.

### CROSS REFERENCE TO RELATED APPLICATIONS

This application claims the benefit of Japanese Priority Patent Application JP 2013-083949 filed Apr. 12, 2013, the entire contents of which are incorporated herein by reference.

### BACKGROUND

The present technology relates to a technical field relevant to a disk drive apparatus that has a first optical pickup and a second optical pickup and performs recording or reproduction of an information signal to both sides of a disk-like recording medium by means of the first optical pickup and the second optical pickup.

There are disk drive apparatuses that perform recording and reproduction of information signals of image data, voice data, etc. to disk-like recording media. Among such disk drive apparatuses, for example, there is included a disk drive apparatus that loads a double-sided disk in which recording and reproduction of an information signal can be performed to both sides, and performs recording and reproduction of the information signal to the both sides of the double-sided disk (for example, refer to JP H10-188456A).

The disk drive apparatus described in JP H10-188456A has: a first chassis at which a first optical pickup and a disk table have been arranged; and a second chassis at which a second optical pickup and a chucking pulley have been arranged, and positioning pins (reference axes) projected upward or downward are provided at a first chassis and a second chassis, respectively.

A disk-like recording medium (double-sided disk) is stored in a state where a part thereof is exposed to an inside of a disk cartridge, and when recording and reproduction of an information signal to the disk-like recording medium is performed, the disk cartridge is conveyed between the first chassis and the second chassis. Positioning holes for positioning the first chassis and the second chassis are formed in the disk cartridge.

When the disk cartridge is conveyed between the first chassis and the second chassis, the first chassis and the second chassis are moved in a direction of approaching to each other in a vertical direction according to operation of a slide cam plate provided as a drive member, the disk-like recording medium is sandwiched by the disk table and the chucking pulley, and then it is chucked.

At this time, the respective positioning pins of the first chassis and the second chassis are inserted in the respective positioning holes of the disk cartridge, respectively, the first chassis and the second chassis are positioned to the disk cartridge and also the first chassis and the second chassis are connected to each other in the vertical direction through the disk cartridge, and the disk cartridge is held by the first chassis and the second chassis.

As described above, the first chassis and the second chassis are positioned to the disk cartridge and are also connected to each other through the disk cartridge, whereby a stable chucking state to the disk-like recording medium by means of the disk table and the chucking pulley is secured, and also a stable holding state of the disk cartridge by means of the first chassis and the second chassis is secured, and recording or reproduction of the information signal to the disk-like recording medium is successfully performed.

### SUMMARY

By the way, in the apparatus in which the first chassis and the second chassis are moved by the drive member like the slide cam plate, and then in which positioning and connection are performed as the disk drive apparatus described in JP H10-188456A, position deviation may occur between respective members depending on assembly accuracy to the drive member, process accuracy of each part, etc.

However, the disk drive apparatus described in JP H10-188456A has such a configuration that cam followers are provided at the first chassis and the second chassis, the cam followers are slidably engaged with cam grooves of the slide cam plate, the cam followers are slid to the cam grooves along with slide operation of the slide cam plate, and that the first chassis and the second chassis are moved in a vertical direction, respectively.

Accordingly, the positioning pins provided at the first chassis and the second chassis deviate to the positioning holes of the disk cartridge depending on assembly accuracy, process accuracy, etc. of each part, and positioning may not be performed smoothly, or chucking to the disk-like recording medium may not be successfully performed.

Consequently, it is desirable for a disk drive apparatus according to an embodiment of the present technology to overcome the above-described problems, and to secure a smooth operation state including positioning operation at the time of chucking to a disk-like recording medium.

According to an embodiment of the present technology, there is provided a disk drive apparatus including a first chassis unit that has a first base chassis and a first pickup base supported by the first base chassis through an elastically deformable insulator, and a second chassis unit that has a second base chassis and a second pickup base supported by the second base chassis through an elastically deformable insulator. At the first pickup base, arranged are a disk table on which a disk-like recording medium is loaded and a first optical pickup that performs recording or reproduction of an information signal to the disk-like recording medium. At the second pickup base, arranged are a chucking pulley that holds the disk-like recording medium by sandwiching the disk-like recording medium together with the disk table and a second optical pickup that performs recording or reproduction of an information signal to the disk-like recording medium. At least one of the first chassis unit and the second chassis unit is moved in a thickness direction of the disk-like recording medium, and the first pickup base and the second pickup base are connected to or separated from each other. Positioning parts for performing positioning of the first pickup base and the second pickup base at a time of connection are provided at the first pickup base and the second pickup base, respectively. The first pickup base and the second pickup base are connected to each other by magnetic forces of magnets.

Consequently, at the time of connection of the first pickup base and the second pickup base, the first pickup base can be displaced to the first base chassis in a direction perpendicular to the thickness direction of the disk-like recording medium by means of the insulator, and also the second pickup base can be displaced to the second base chassis in the direction perpendicular to the thickness direction of the disk-like recording medium.

According to an embodiment of the present technology, the first chassis unit and the second chassis unit may be moved in the thickness direction of the disk-like recording medium, and the first pickup base and the second pickup base are connected to or separated from each other.

Consequently, since in a total moving stroke of the first base chassis and the second base chassis, the moving stroke is distributed into the first base chassis and the second base chassis, it may become possible to minimize movement amounts of the first base chassis and the second base chassis, respectively.

According to an embodiment of the present technology, the first chassis unit and the second chassis unit may be simultaneously moved.

Consequently, the first pickup base and the second pickup base are simultaneously moved.

According to an embodiment of the present technology, wherein provided are cam sliders that are moved in a predetermined direction and move the first chassis unit and the second chassis unit.

Consequently, the first chassis unit and the second chassis unit, which are separate members, are moved by the cam slider.

According to an embodiment of the present technology, cam holes may be formed in the cam sliders, guided pins slidably engaged with the cam holes are provided at the first base chassis and the second base chassis, respectively. When the cam sliders are moved in the predetermined direction, the guided pins of the first base chassis and the second base chassis may be slid to the cam holes, and the first chassis unit and the second chassis unit may be moved.

Consequently, the first pickup base supported by the first base chassis and the second pickup base supported by the second base chassis are moved along with operation of the first base chassis and the second base chassis by means of the cam slider.

According to an embodiment of the present technology, one of the positioning parts of the first pickup base and the positioning parts of the second pickup base may be provided as positioning pins, and the other one of the positioning parts of the first pickup base and the positioning parts of the second pickup base is formed as positioning holes.

Consequently, the positioning pins are inserted in the positioning holes, and the first pickup base and the second pickup base are positioned.

According to an embodiment of the present technology, a pair of first connection parts may be provided at the first pickup base, a pair of second connection parts connected to the pair of first connection parts, respectively, may be provided at the second pickup base, the positioning holes may be formed in the pair of first connection parts or the pair of second connection parts, respectively. One of the positioning holes may be formed in an elongated shape that extends in a direction where the pair of first connection parts or the pair of second connection parts are aligned.

Consequently, the positioning pin does not easily get contact with an opening edge of the elongated positioning hole at the time of insertion thereof in the elongated positioning hole.

According to an embodiment of the present technology, the elongated positioning hole is formed in one of the first connection part or one of the second connection part. Connection of the connection part in which the elongated positioning hole has been formed with the other connection part is performed in advance of connection of the connection part in which the elongated positioning hole has not been formed with the other connection part.

Consequently, the positioning pin is first inserted in the elongated positioning hole.

According to an embodiment of the present technology, separation of one of the first connection parts from one of the second connection parts is performed in advance of separation of the other one of the first connection parts from the other one of the second connection parts.

Consequently, release of attraction of the magnets on each connection part is sequentially performed.

According to the present technology, at the time of positioning of the first pickup base and the second pickup base, the first pickup base and the second pickup base are relatively displaced, position deviation is absorbed, and also the first pickup base and the second pickup base are easily connected to each other by the magnets, and a smooth operation state including positioning operation at the time of chucking to the disk-like recording medium can be secured.

### BRIEF DESCRIPTION OF THE DRAWINGS

FIG. 1 shows a mode for carrying out a disk drive apparatus according to an embodiment of the present technology together with FIGS. 2 to 18, and the present drawing is a perspective view of the disk drive apparatus;

FIG. 2 is an exploded perspective view of the disk drive apparatus;

FIG. 3 is an exploded perspective view of a first chassis unit;

FIG. 4 is a perspective view of the first chassis unit;

FIG. 5 is an exploded perspective view of a second chassis unit;

FIG. 6 is a perspective view of the second chassis unit;

FIG. 7 is an enlarged perspective view of a cam slider;

FIG. 8 shows operation of the disk drive apparatus together with FIGS. 9 to 18, and the present figure is a perspective view showing an initial state;

FIG. 9 is a schematic side view showing the initial state;

FIG. 10 is a schematic cross-sectional view showing the initial state;

FIG. 11 is a schematic side view showing a state where a disk-like recording medium has been conveyed to a chucking position in the initial state;

FIG. 12 is a schematic cross-sectional view showing a state where the disk-like recording medium has been conveyed to the chucking position in the initial state;

FIG. 13 is a schematic side view showing a half-way state where the first chassis unit and the second chassis unit are moved in a vertical direction;

FIG. 14 is a schematic cross-sectional view showing the half-way state where the first chassis unit and the second chassis unit are moved in the vertical direction;

FIG. 15 is an enlarged side view showing as a cross section a part of a state where a rear positioning pin has been inserted in a positioning hole;

FIG. 16 is a schematic side view showing a state where the first chassis unit and the second chassis unit have been moved in the vertical direction, and where a first pickup base and a second pickup base have been connected to each other;

FIG. 17 is a schematic cross-sectional view showing a state where the first chassis unit and the second chassis unit have been moved in the vertical direction, and where a first pickup base and a second pickup base have been connected to each other; and

FIG. 18 is an enlarged side view showing as a cross section a part of a state where a front positioning pin has been inserted in a positioning hole.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, an embodiment of a disk drive apparatus of the present technology will be explained according to accompanying drawings.

In the following explanation, a direction where a disk-like recording medium is conveyed toward the disk drive apparatus at the time of loading is set as a rear (a retraction direction), a direction where the disk-like recording medium is conveyed from the disk drive apparatus at the time of ejection is set as a front (discharge direction), and a horizontal direction is indicated in a state when the disk drive apparatus is seen from the front, whereby the front/rear, vertical, and horizontal directions are indicated.

Note that the front/rear, vertical, and horizontal directions indicated hereinafter are for convenience of explanation, and that the carrying out of the present technology is not limited to these directions.

### [Configuration of Disk Drive Apparatus]

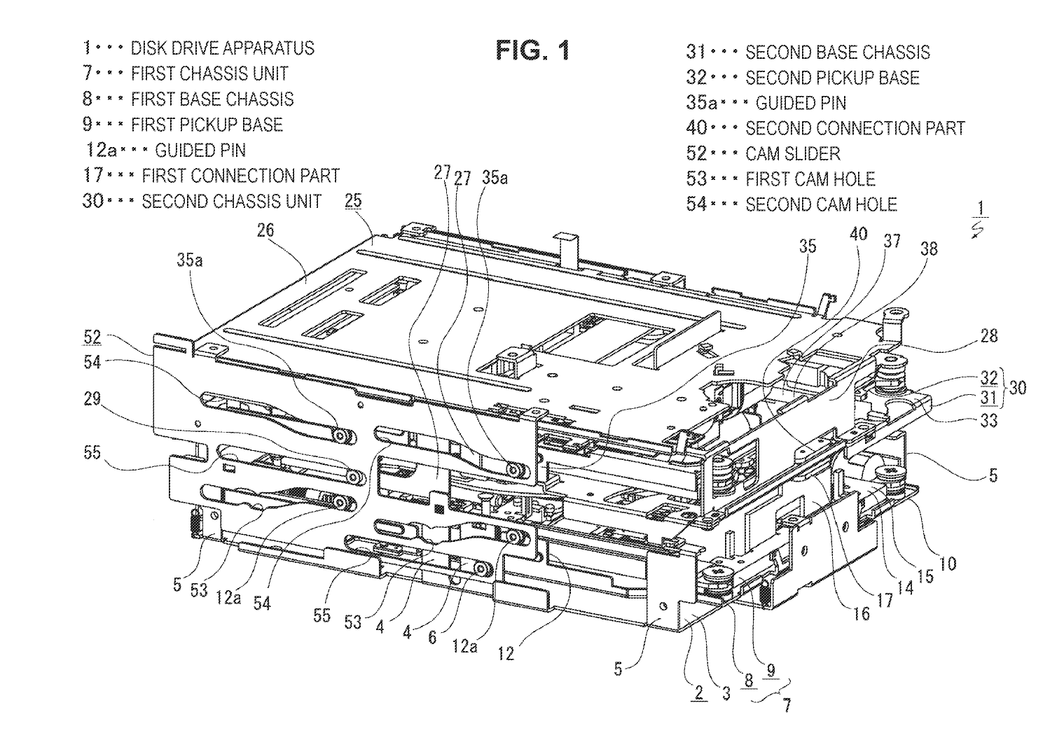

First, a specific configuration of a disk drive apparatus 1 will be explained (refer to FIGS. 1 to 7).

### <First Base Frame>

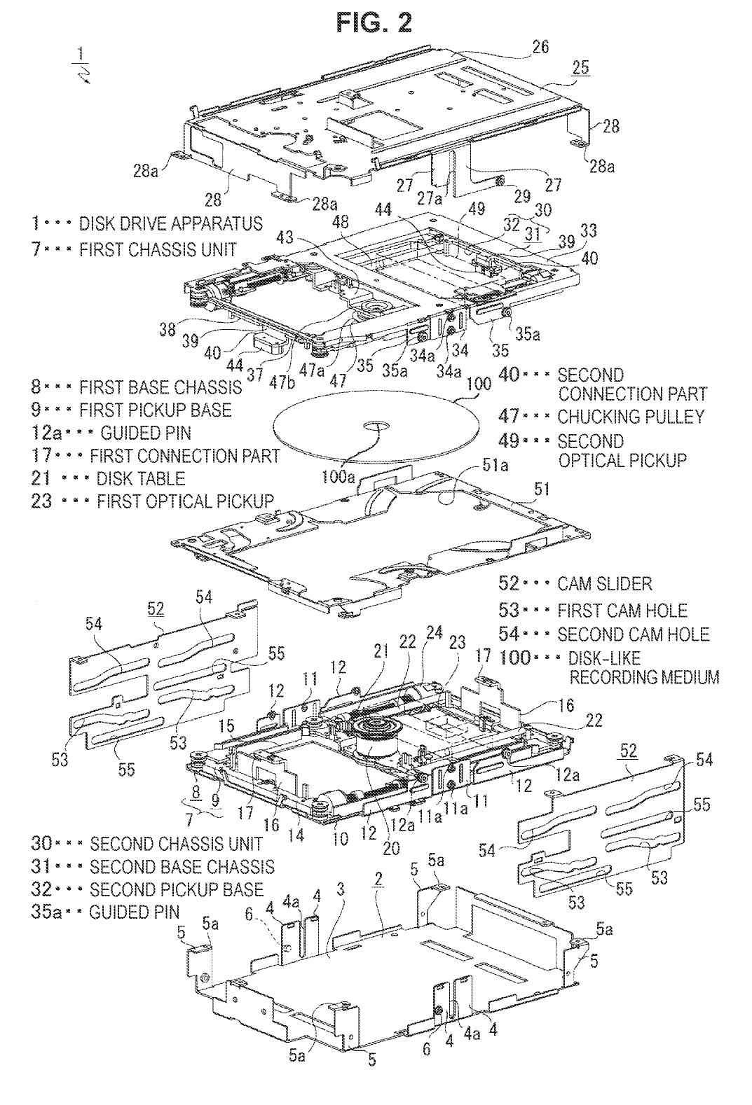

The disk drive apparatus 1 has a first base frame 2 (refer to FIGS. 1 and 2). The first base frame 2 has: a bottom surface plate part 3 formed substantially as a rectangle having an elongated outer shape; a pair of side surface plate parts 4, 4, . . . projected upward from both right and left edges of the bottom surface plate part 3, respectively; and attachment plate parts 5, 5, . . . projected upward from an outer peripheral edge of the bottom surface plate part 3, respectively.

The side surface plate parts 4 and 4 are provided side by side substantially at a center in a front/rear direction of the first base frame 2, a slit that is opened upward and vertically extends is formed between the side surface plate parts 4 and 4, and this slit is formed as a guidance restriction hole 4a. A guidance restriction pin 6 is attached to an outer surface of the one side surface plate part 4.

Attachment pieces 5a, 5a, . . . folded inward are provided at upper ends of the attachment plate parts 5, 5, . . . .

### <First Chassis Unit>

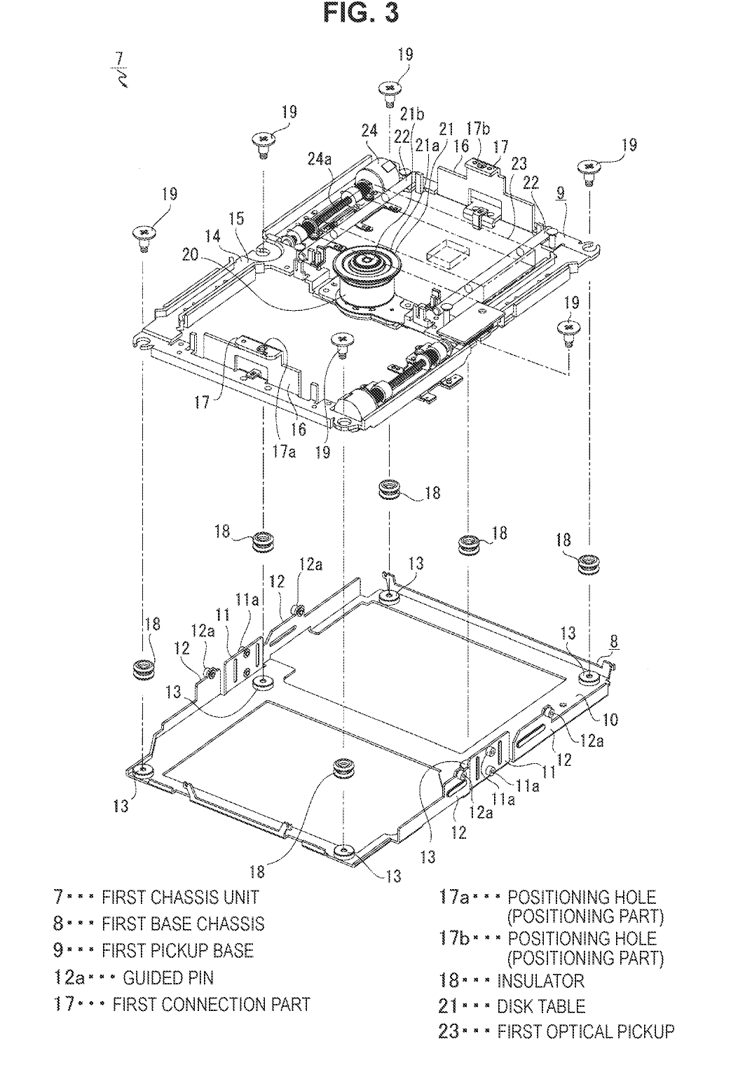

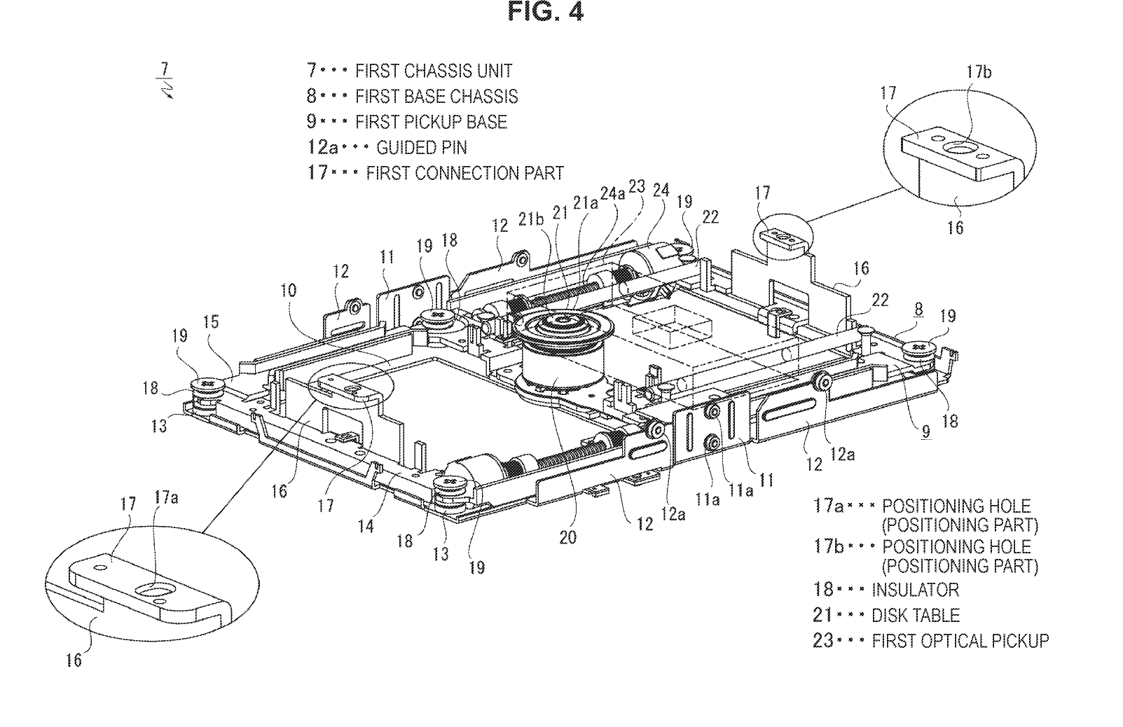

A first chassis unit 7 is movably supported in the vertical direction by the side surface plate parts 4, 4, . . . of the first base frame 2. The first chassis unit 7 has a first base chassis 8 and a first pickup base 9 (refer to FIGS. 3 and 4).

The first base chassis 8 has: a base surface part 10 that faces the vertical direction; first side surface parts 11 and 11 projected upward from both right and left edges of the base surface part 10, respectively; and second side surface parts 12, 12, . . . projected upward from both right and left edges of the base surface part 10, respectively.

The base surface part 10 is formed in an elongated substantially rectangular shape.

The first side surface part 11 is located slightly closer to an inside than the second side surface part 12, and guided pins 11a and 11a are provided at an outer surface of the first side surface part 11 so as to be vertically spaced aside from each other. The guided pins 11a and 11a are vertically slidably engaged with the guidance restriction hole 4a formed between the side surface plate parts 4 and 4 of the first base frame 2, and movement in the horizontal direction of the first base chassis 8 is restricted by the first base frame 2.

The second side surface parts 12, 12, . . . are located at a front and a rear sandwiching the first side surface parts 11 and 11, respectively. A guided pin 12a is provided at an outer surface of the second side surface part 12.

Respectively upwardly projected attachment projections 13, 13, . . . are provided at an outer periphery of the base surface part 10.

The first pickup base 9 is attached to the base surface part 10 of the first base chassis 8 through the attachment projections 13, 13, . . . . Desired each part of the first pickup base 9 is arranged at an arrangement plate 14.

The arrangement plate 14 is formed of a magnetic metal material, and has: a base surface part 15 that faces the vertical direction and is formed in an elongated substantially rectangular shape; projecting surface parts 16 and 16 projected upward from both front and rear ends of the base surface part 15, respectively; and first connection parts 17 and 17 projected forward from upper ends of the projecting surface parts 16 and 16, respectively. Positioning holes 17a and 17b are formed in the first connection parts 17 and 17, respectively, and, for example, the positioning hole 17a located at a front side is formed in an elongated shape that is long in the front/rear direction. The positioning holes 17a and 17b function as positioning parts for positioning the first pickup base 9 and a second pickup base, which will be mentioned later.

Insulators 18, 18, . . . are connected to an outer periphery of the base surface part 15. The insulators 18, 18, . . . are attached to the attachment projections 13, 13, . . . by attachment screws 19, 19, . . . , respectively, and thereby the first pickup base 9 is connected to the first base chassis 8. Accordingly, the first pickup base 9 can be displaced to the first base chassis 8 in a horizontal surface in a range where the insulators 18, 18, . . . are elastically deformed.

A spindle motor 20 is arranged substantially at a center of the base surface part 15 in the arrangement plate 14, and a disk table 21 is coupled to an output shaft of the spindle motor 20. Accordingly, the disk table 21 is rotated by a drive force of the spindle motor 20.

An outer periphery of the disk table 21 is provided as a table part 21a, and an inside portion of the table part 21a is provided as an upwardly projected centering projection 21b. For example, a metal plate formed in an annular shape, which is not shown, is embedded in the centering projection 21b.

Guide shafts 22 and 22 that extend in a longitudinal direction are arranged at an upper surface side of the arrangement plate 14 so as to be spaced aside from each other at right and left sides. A first optical pickup 23 is movably supported by the guide shafts 22 and 22.

A drive motor 24 is arranged at the arrangement plate 14. The drive motor 24 has a lead screw 24a that extends in the front/rear direction, and the lead screw 24a is screwed to a part of the first optical pickup 23. Accordingly, the first optical pickup 23 is guided by the guide shafts 22 and 22 by means of the drive force of the drive motor 24, and is moved in a direction contacted and separated with/from the disk table 21 (in the front/rear direction).

### <Second Base Frame>

A second base frame 25 is arranged above the first base frame 2 (refer to FIGS. 1 and 2). The second base frame 25 has: a top surface plate part 26 formed substantially as a rectangle having an elongated outer shape; a pair of side surface plate parts 27, 27, . . . projected downward from both right and left edges of the top surface plate part 26, respectively; and attachment plate parts 28, 28, . . . projected downward from an outer periphery of the top surface plate part 26, respectively.

The side surface plate parts 27 and 27 are provided side by side substantially at a center in a front/rear direction of the second base frame 25, a slit that is opened downward and vertically extends is formed between the side surface plate parts 27 and 27, and this slit is formed as a guidance restriction hole 27a. A guidance restriction pin 29 is attached to an outer surface of the one side surface plate part 27.

Attachment pieces 28a, 28a, . . . folded inward or outward are provided at upper ends of the attachment plate parts 28, 28, . . . .

### <Second Chassis Unit>

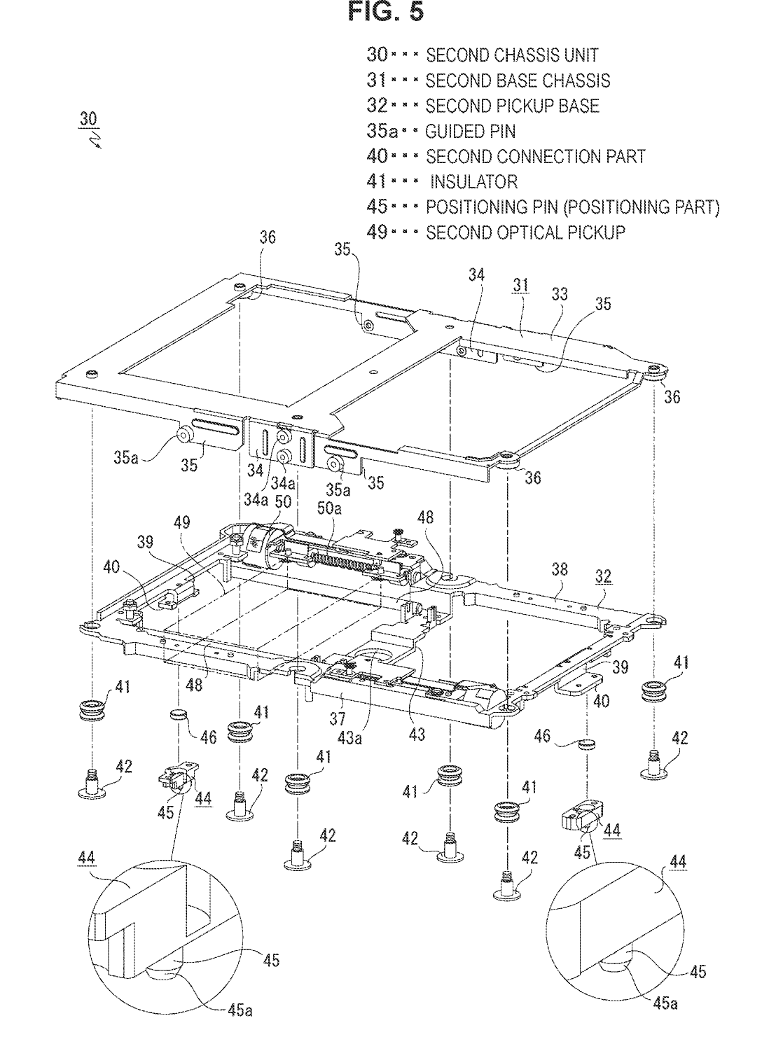

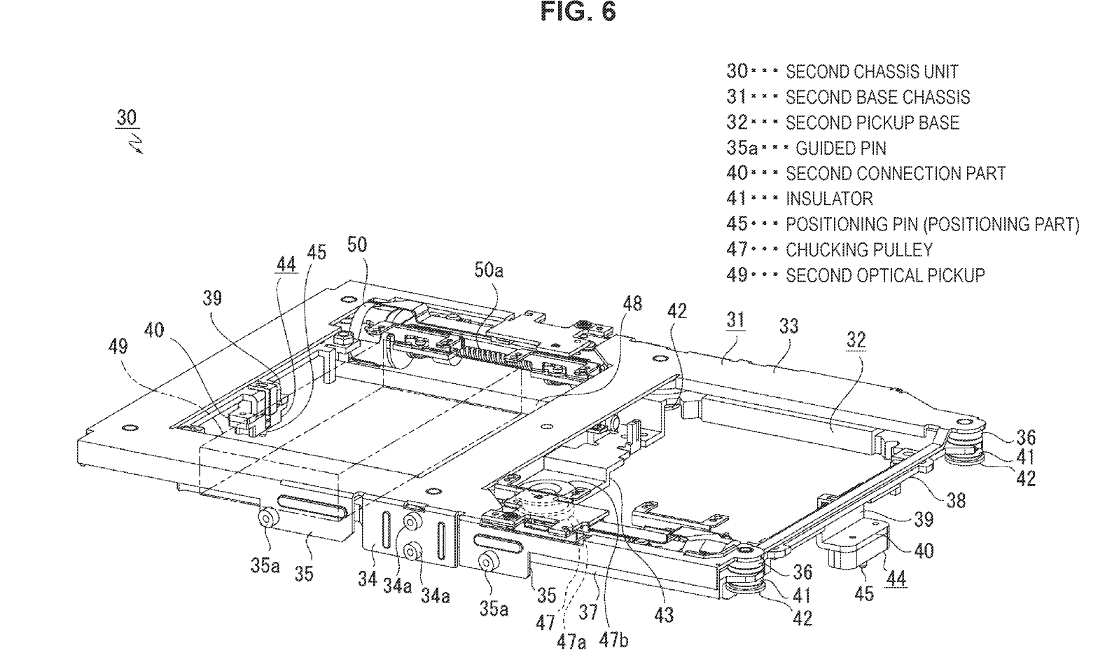

A second chassis unit 30 is supported movably in the vertical direction above the first chassis unit 7 by the side surface plate parts 27, 27, . . . of the second base frame 25. The second chassis unit 30 has a second base chassis 31 and a second pickup base 32 (refer to FIGS. 5 and 6).

The second base chassis 31 has: a base surface part 33 formed in an elongated substantially rectangular shape; first side surface parts 34 and 34 projected downward from both right and left edges of the base surface part 33, respectively; and second side surface parts 35, 35, . . . projected downward from both right and left edges of the base surface part 33, respectively.

The first side surface part 34 is located slightly closer to an inside than the second side surface part 35, and guided pins 34a and 34a are provided at an outer surface of the first side surface part 34 so as to be vertically spaced aside from each other. The guided pins 34a and 34a are vertically slidably engaged with the guidance restriction hole 27a formed between the side surface plate parts 27 and 27 of the second base frame 25, and movement in the horizontal direction of the second base chassis 31 is restricted by the second base frame 25.

The second side surface parts 35, 35, . . . are located at a front and a rear sandwiching the first side surface parts 34 and 34, respectively. A guided pin 35a is provided at an outer surface of the second side surface part 35.

Downwardly projected attachment projections 36, 36, . . . are provided at an outer periphery of the base surface part 33.

The second pickup base 32 is attached to the base surface part 33 of the second base chassis 31 through the attachment projections 36, 36, . . . . Desired each part of the second pickup base 32 is arranged at an arrangement plate 37.

The arrangement plate 37 has: a base surface part 38 that faces the vertical direction and is formed in an elongated substantially rectangular shape; projecting surface parts 39 and 39 projected downward from both front and rear ends of the base surface part 38, respectively; and second connection parts 40 and 40 projected outward from lower ends of the projecting surface parts 39 and 39, respectively.

Insulators 41, 41, . . . are connected to an outer periphery of the base surface part 38. The insulators 41, 41, . . . are attached to the attachment projections 36, 36, . . . by attachment screws 42, 42, . . . , respectively, and thereby the second pickup base 32 is connected to the second base chassis 31. Accordingly, the second pickup base 32 can be displaced to the second base chassis 31 in a horizontal surface in a range where the insulators 41, 41, . . . are elastically deformed.

At the arrangement plate 37, provided is a pulley supporting part 43 whose both right and left ends are continuous with both right and left ends of the base surface part 38, respectively. The pulley supporting part 43 is continuous with both right and left ends substantially in a center in the front/rear direction of the base surface part 38, and is located below the base surface part 38. A vertically penetrated support hole 43a is formed in a center in a horizontal direction of the pulley supporting part 43.

Magnet covers 44 and 44 formed of a resin material are attached to bottom surfaces of the second connection parts 40 and 40 of the arrangement plate 37, respectively. A downwardly projected positioning pin 45 is provided at the magnet cover 44. The positioning pin 45 functions as a positioning part for positioning the first pickup base 9 and the second pickup base 32. A lower end of the positioning pin 45 is provided as a taper part 45a whose diameter becomes smaller toward a lower side. A magnet 46 is inserted and held inside the magnet cover 44.

A chucking pulley 47 is rotatably supported by the pulley supporting part 43. The chucking pulley 47 includes: a pulley body 47a; a connecting ring 47b; and a magnet, which is not shown. The pulley body 47a is inserted in the support hole 43a from a lower side, and the connecting ring 47b is connected to the pulley body 47a from an upper side, whereby the chucking pulley 47 is supported by the pulley supporting part 43, and can be moved vertically to the pulley supporting part 43 in a predetermined range. The magnet is arranged inside the pulley body 47a.

Guide shafts 48 and 48 that extend in the longitudinal direction are arranged at a lower surface side of the arrangement plate 37 so as to be spaced aside from each other at right and left sides.

A second optical pickup 49 is movably supported by the guide shafts 48 and 48.

A drive motor 50 is arranged at the arrangement plate 37. The drive motor 50 has a lead screw 50a that extends in the front/rear direction, and the lead screw 50a is screwed to a part of the second optical pickup 49. Accordingly, the second optical pickup 49 is guided by the guide shafts 48 and 48 by means of a drive force of the drive motor 50, and is moved in a direction contacted and separated with/from the chucking pulley 47 (in the front/rear direction).

### <Center Chassis>

A center chassis 51 formed in a substantially frame-like substantially rectangular shape is arranged between the first base frame 2 and the second base frame 25 (refer to FIG. 2). A space inside the center chassis 51 is formed as an insertion hole 51a.

The center chassis 51 is attached to the first base frame 2 and the second base frame 25 in a state of being sandwiched between the attachment pieces 5a, 5a, . . . of the attachment plate parts 5, 5, . . . in the first base frame 2 and the attachment pieces 28a, 28a, . . . of the attachment plate parts 28, 28, . . . in the second base frame 25.

A disk holding mechanism, which is not shown, that holds a disk-like recording medium 100 is supported by the center chassis 51.

### <Cam Slider>

Cam sliders 52 and 52 are supported movably in the front/rear direction at outer surface sides of the side surface plate parts 4, 4, . . . of the first base frame 2 and the side surface plate parts 27, 27, . . . of the second base frame 25, respectively (refer to FIGS. 1 and 2). The cam slider 52 is formed in a plate shape that faces the horizontal direction, and is moved in the front/rear direction by a drive mechanism, which is not shown.

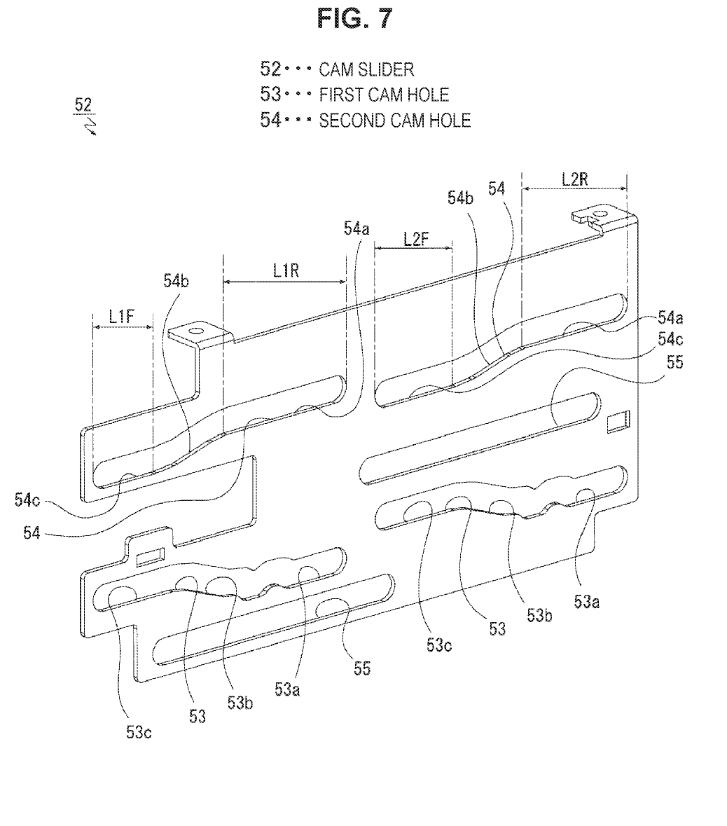

First cam holes 53 and 53 are formed in the cam slider 52 so as to be spaced aside from each other at front and rear sides (refer to FIG. 7). The first cam hole 53 includes: a rear cam part 53a that extends in the front/rear direction; an inclined cam part 53b that is continuous with a front end of the rear cam part 53a and is displaced more upward toward the front; and a front cam part 53c that is continuous with a front end of the inclined cam part 53b and extends in the front/rear direction.

In the cam slider 52, second cam holes 54 and 54 are formed above the first cam holes 53 and 53, respectively so as to be spaced aside from each other at front and rear sides. The second cam hole 54 includes: a rear cam part 54a that extends in the front/rear direction; an inclined cam part 54b that is continuous with a front end of the rear cam part 54a and is displaced more downward toward the front; and a front cam part 54c that is continuous with a front end of the inclined cam part 54b and extends in the front/rear direction.

In the second cam holes 54 and 54, for example, a length L1R in the front/rear direction of the rear cam part 54a located at a front side is made slightly longer than a length L2R in the front/rear direction of the rear cam part 54a located at a rear side, and a length L2F in the front/rear direction of the front cam part 54c located at the rear side is made slightly longer than a length L1F in the front/rear direction of the front cam part 54c located at the front side. In the second cam holes 54 and 54, lengths in the front/rear direction of the inclined cam parts 54b and 54b are made the same as each other.

In the cam slider 52, guided holes 55 and 55 that extend in the front/rear direction are formed at a lower side of the front first cam hole 53 and an upper side of the rear first cam hole 53.

The guidance restriction pin 6 of the first base frame 2 and the guidance restriction pin 29 of the second base frame 25 are inserted in the guided holes 55 and 55, respectively, and thereby the cam slider 52 is supported movably in the front/rear direction to the first base frame 2 and the second base frame 25 (refer to FIG. 1).

The guided pins 12a and 12a of the first chassis unit 7 are slidably engaged with the first cam holes 53 and 53 of the cam slider 52, respectively, and the first chassis unit 7 is supported movably in the vertical direction by the cam sliders 52 and 52.

The guided pins 35a and 35a of the second chassis unit 30 are slidably engaged with the second cam holes 54 and 54 of the cam slider 52, respectively, and the second chassis unit 30 is supported by the cam sliders 52 and 52 movably in the vertical direction.

Accordingly, when the cam sliders 52 and 52 are moved in the front/rear direction, the guided pins 11a and 11a of the first base chassis 8 are guided to the guidance restriction hole 4a of the first base frame 2, and also the guided pins 34a and 34a of the second base chassis 31 are guided to the guidance restriction hole 27a of the second base frame 25, and the guided pins 12a and 12a are slid in the first cam holes 53 and 53 of the cam slider 52 and the first chassis unit 7 is moved in the vertical direction, and also the guided pins 35a and 35a are slid in the second cam holes 54 and 54 of the cam slider 52 and the second chassis unit 30 is moved in the vertical direction.

### [Operation of Disk Drive Apparatus]

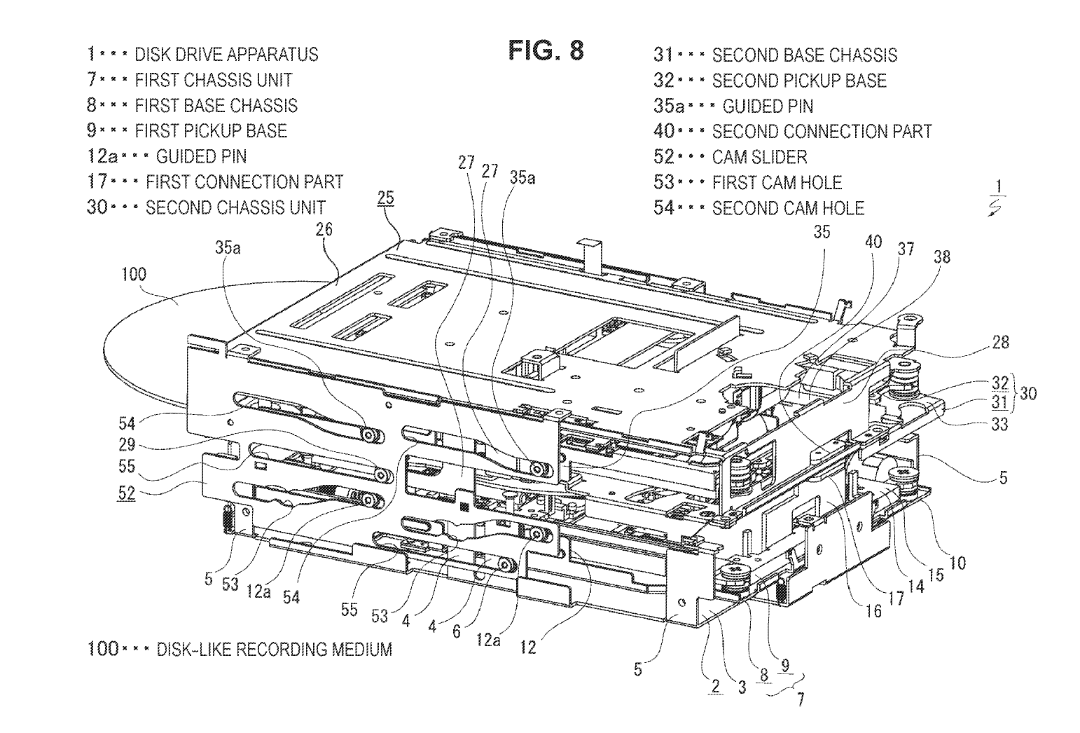

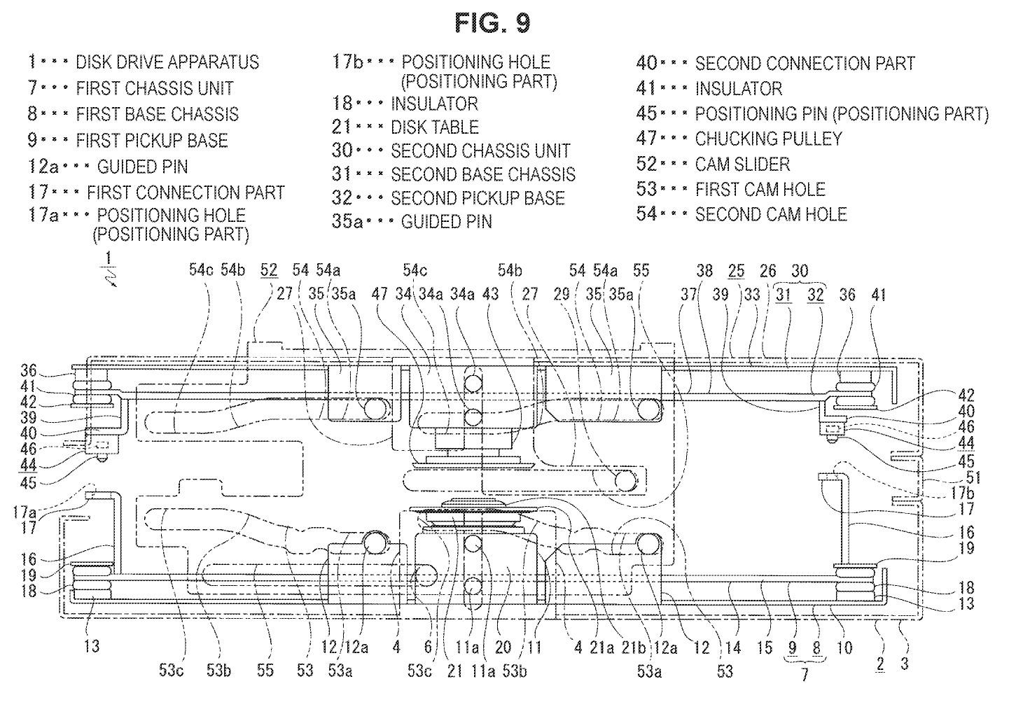

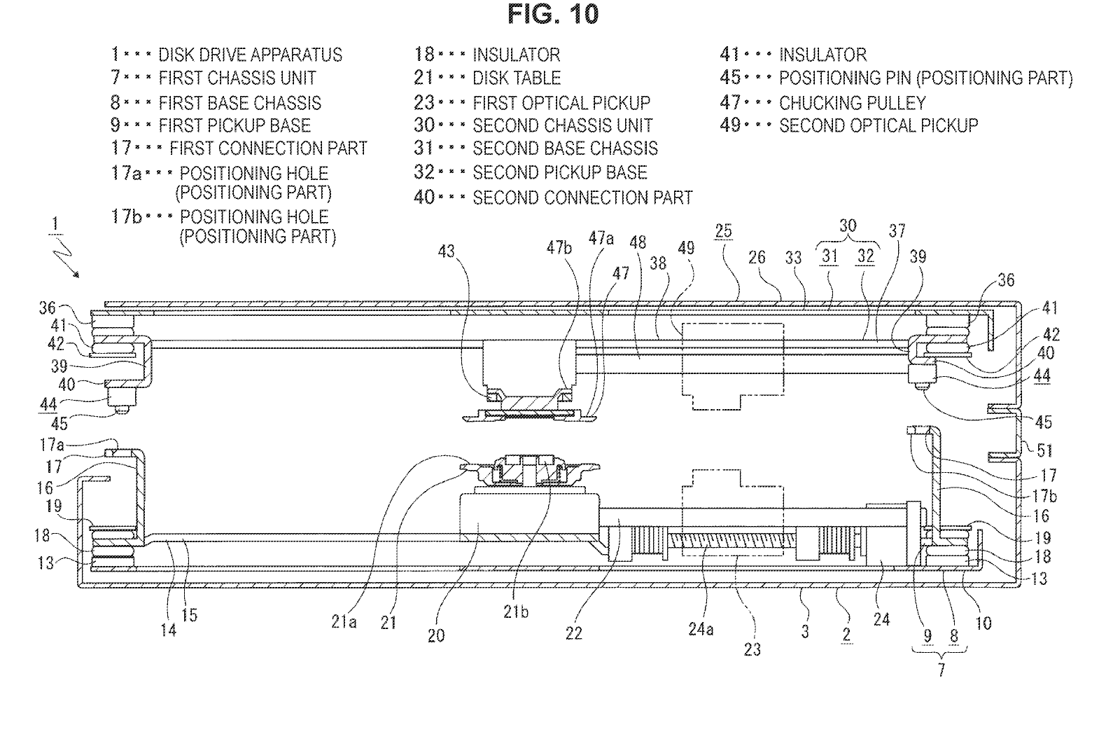

Hereinafter, will be explained operation of the disk drive apparatus 1 to the disk-like recording medium 100 at the time of chucking (refer to FIGS. 8 to 18).

### <Outline of Operation>

First, an outline of operation relating to chucking operation will be explained. The disk-like recording medium 100 is ejected from a disk cartridge, which is not shown, is conveyed in a retraction direction (rearward) to a chucking position in the disk drive apparatus 1 by loading operation of a conveyance device, which is not shown, and is chucked at the chucking position, and recording or reproduction of an information signal is performed. In addition, when recording or reproduction of the information signal is ended, chucking of the disk-like recording medium 100 is released, and the disk-like recording medium 100 is conveyed in a discharge direction (forward) by eject operation of the conveyance device and is stored in the disk cartridge.

Note that the disk-like recording medium 100 is, for example, held in the disk holding mechanism supported by the center chassis 51 in a state of being conveyed to the chucking position by the loading operation of the conveyance device.

### <Initial State>

Next, will be explained an initial state of each part in the disk drive apparatus 1 at the time of chucking operation (refer to FIGS. 8 to 10).

The cam sliders 52 and 52 are held at front movable ends, respectively. At this time, the guidance restriction pin 6 of the first base frame 2 and the guidance restriction pin 29 of the second base frame 25 are engaged with rear ends of the guided holes 55 and 55 in the cam slider 52, respectively. In addition, the guided pins 12a and 12a of the first chassis unit 7 are engaged with rear ends of the rear cam parts 53a and 53a of the first cam holes 53 and 53 in the cam slider 52, respectively, and the guided pins 35a and 35a of the second chassis unit 30 are engaged with rear ends of the rear cam parts 54a and 54a of the second cam holes 54 and 54 in the cam slider 52, respectively.

Accordingly, the first chassis unit 7 is held at a lower movable end, and the second chassis unit 30 is held at an upper movable end. The first chassis unit 7 is held at the lower movable end, and the second chassis unit 30 is held at the upper movable end, whereby the first pickup base 9 and the second pickup base 32 are located most spaced aside from each other in the vertical direction. Accordingly, the disk table 21 and the chucking pulley 47 are located most spaced aside from each other in the vertical direction.

### <Chucking Operation>

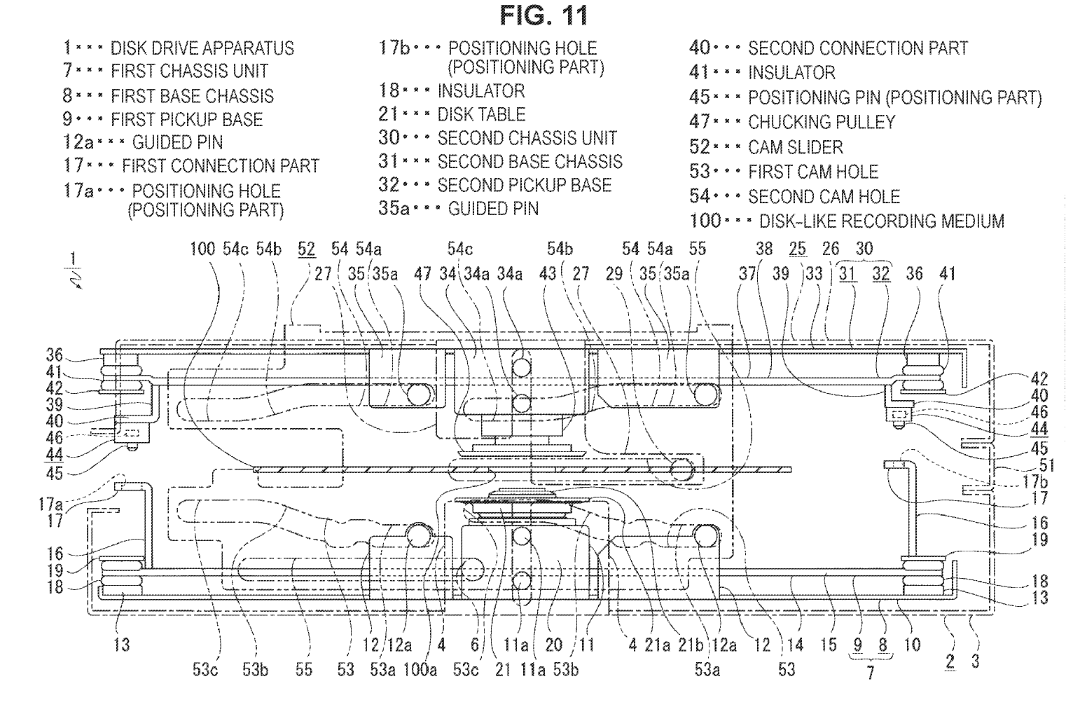

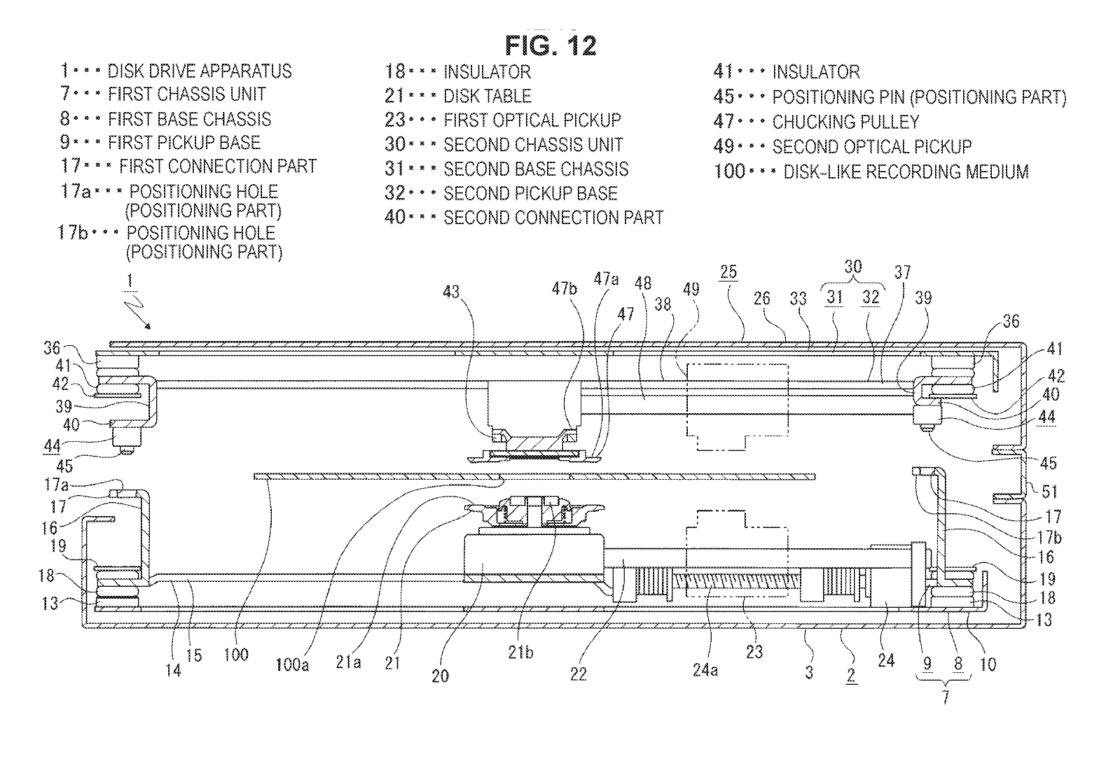

The disk-like recording medium 100 is ejected from the disk cartridge, and is conveyed in the retraction direction (rearward) by the loading operation of the conveyance device (refer to FIGS. 11 and 12). The disk-like recording medium 100 is conveyed in an upper surface side of the center chassis 51, and is conveyed to a chucking position where a center of a center hole 100a coincides with a center axis of the disk table 21 and a center axis of the chucking pulley 47. The disk-like recording medium 100 is held by the disk holding mechanism supported by the center chassis 51 at the chucking position.

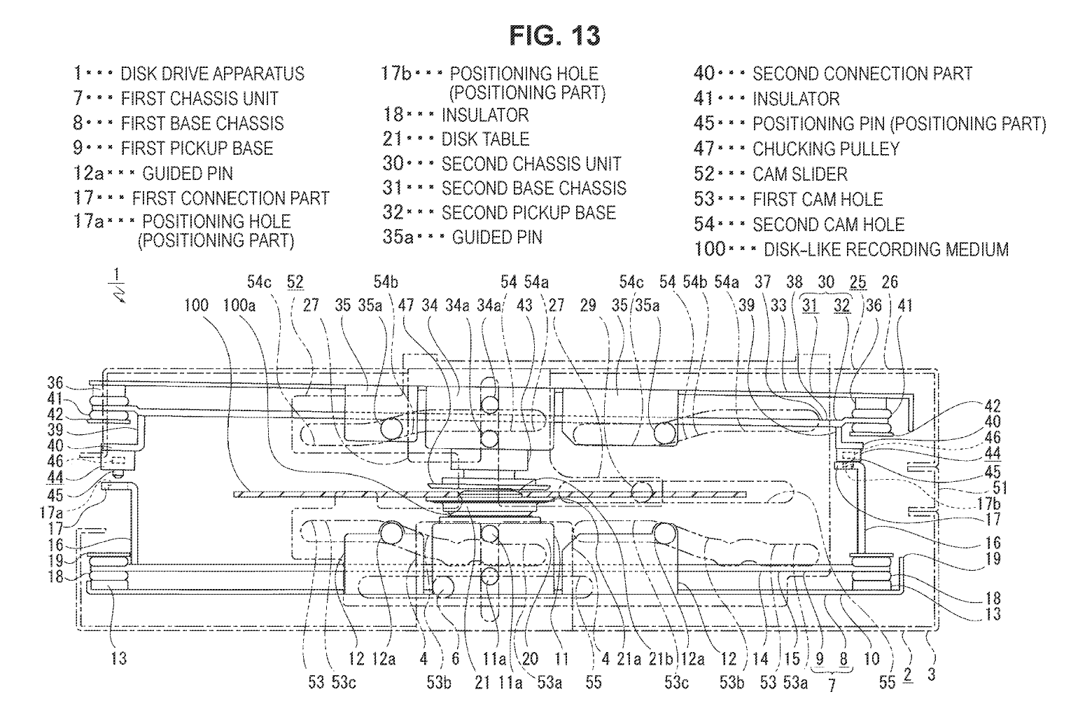

When the disk-like recording medium 100 is conveyed to the chucking position, the cam sliders 52 and 52 are synchronously moved rearward by the drive mechanism (refer to FIG. 13).

Since the guidance restriction pin 6 of the first base frame 2 and the guidance restriction pin 29 of the second base frame 25 are engaged with the guided holes 55 and 55, respectively, the cam slider 52 is guided by the guidance restriction pins 6 and 29, and is moved rearward.

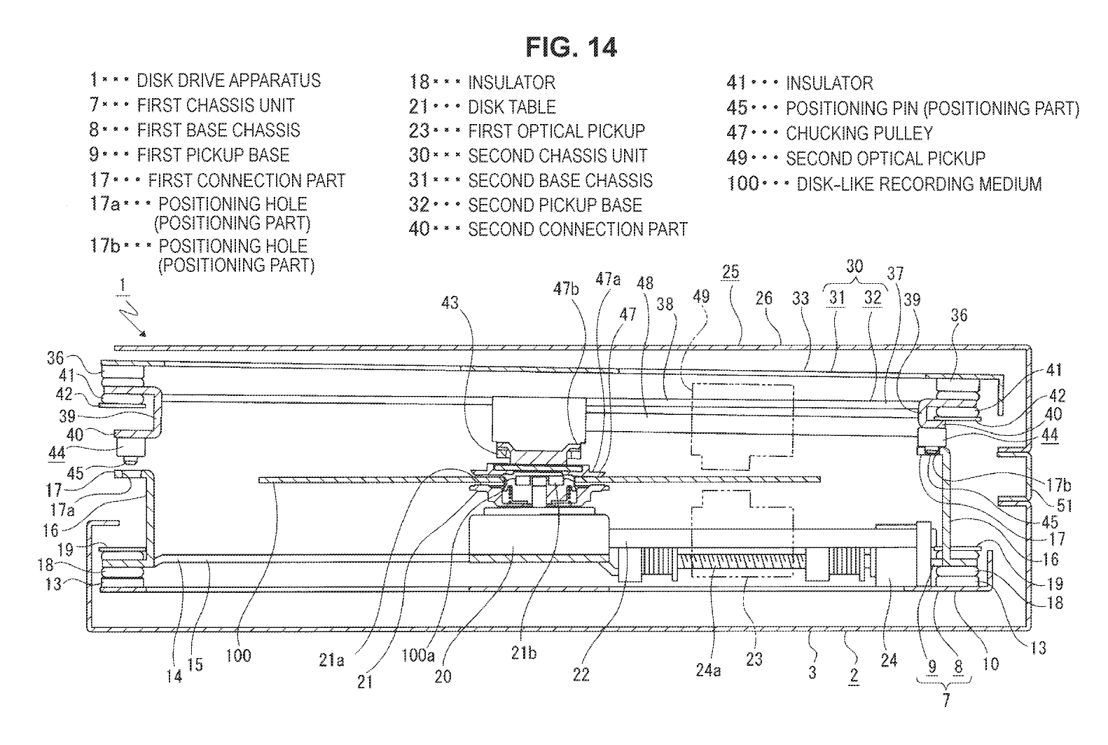

When the cam slider 52 is moved rearward, the guided pins 12a and 12a of the first chassis unit 7 are slid toward the front cam parts 53c and 53c through the inclined cam parts 53b and 53b from the rear cam parts 53a and 53a of the first cam holes 53 and 53, respectively, and the guided pins 35a and 35a of the second chassis unit 30 are slid toward the front cam parts 54c and 54c through the inclined cam parts 54b and 54b from the rear cam parts 54a and 54a of the second cam holes 54 and 54, respectively. Accordingly, the first chassis unit 7 is moved upward and also the second chassis unit 30 is moved downward, and the disk table 21 and the chucking pulley 47 approach to each other. At this time, the disk table 22 is inserted through the insertion hole 51a of the center chassis 51, and is moved upward (refer to FIG. 14).

As described above, in the second cam holes 54 and 54, the length L2F in the front/rear direction of the front cam part 54c located at the rear side is made slightly longer than the length L1F in the front/rear direction of the front cam part 54c located at the front side.

Accordingly, as described above, when the cam slider 52 is moved rearward, and the guided pins 35a and 35a are slid toward the front cam parts 54c and 54c from the rear cam parts 54a and 54a, in a half-way state, the rear guided pin 35a becomes a state of being engaged with the front cam part 54c, the front guided pin 35a becomes a state of being engaged with the inclined cam part 54b, and the second chassis unit 30 is made into a state of being slightly inclined forward (refer to FIG. 13).

The second chassis unit 30 is made into the state of being slightly inclined forward, and thereby the positioning pin 45 of the magnet cover 44 attached to the rear second connection part 40 in the second pickup base 32 is inserted in the rear positioning hole 17b formed in the first connection part 17 of the first pickup base 9.

At this time, in the first chassis unit 7, the first pickup base 9 is connected to the first base chassis 8 through the insulators 18, 18, . . . , and may be displaced to the first base chassis 8 in a horizontal surface in a range where the insulators 18, 18, . . . are elastically deformed. In addition, in the second chassis unit 30, the second pickup base 32 is connected to the second base chassis 31 through the insulators 41, 41, . . . , and may be displaced to the second base chassis 31 in a horizontal surface in a range where the insulators 41, 41, . . . are elastically deformed.

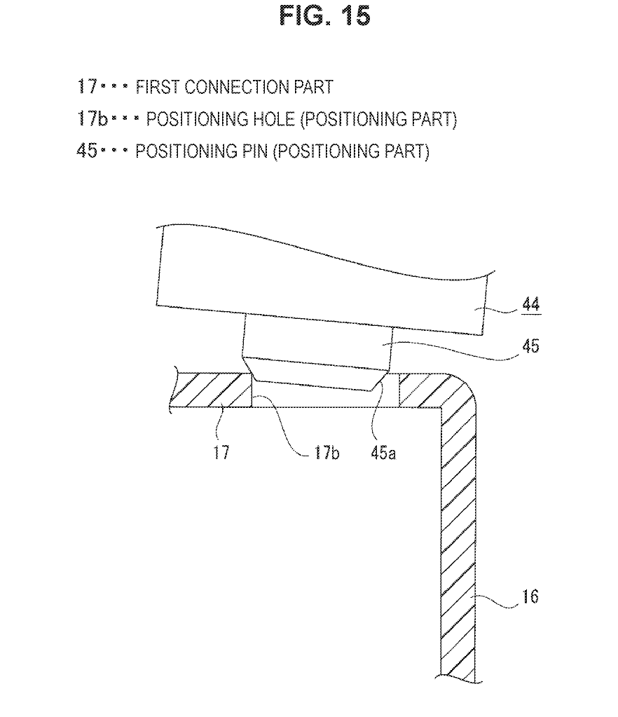

Accordingly, when the positioning pin 45 is inserted in the positioning hole 17b, also in a case where positions of the positioning pin 45 and the positioning hole 17b are slightly deviated in the horizontal surface, the taper part 45a whose diameter is made smaller than the other portion is slid to an opening edge of the positioning hole 17b (refer to FIG. 15), the first pickup base 9 and the second pickup base 32 are displaced to the first base chassis 8 and the second base chassis 31, respectively, and the positioning pin 45 is reliably inserted in the positioning hole 17b.

Simultaneously, the disk table 21 and the chucking pulley 47 approach to each other, and thereby the centering projection 21b of the disk table 21 is inserted in the center hole 100a of the disk-like recording medium 100 from a lower side (refer to FIGS. 13 and 14). When the centering projection 21b of the disk table 21 is inserted in the center hole 100a of the disk-like recording medium 100, holding of the disk-like recording medium 100 by the disk holding mechanism is released. The disk-like recording medium 100 is pushed up by the disk table 21.

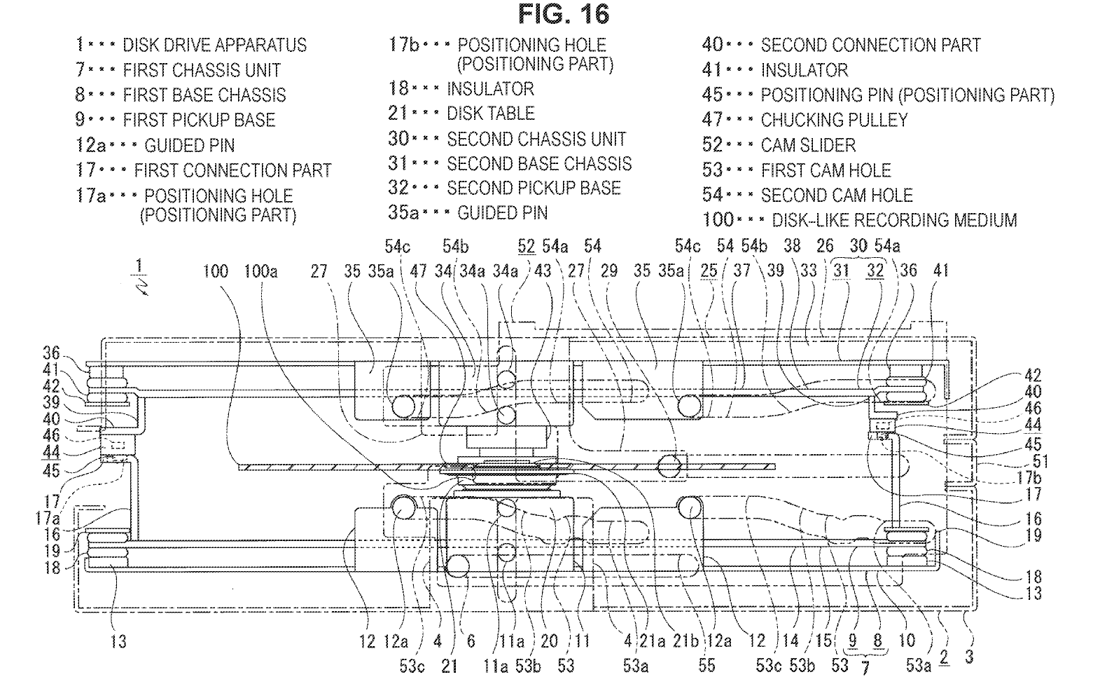

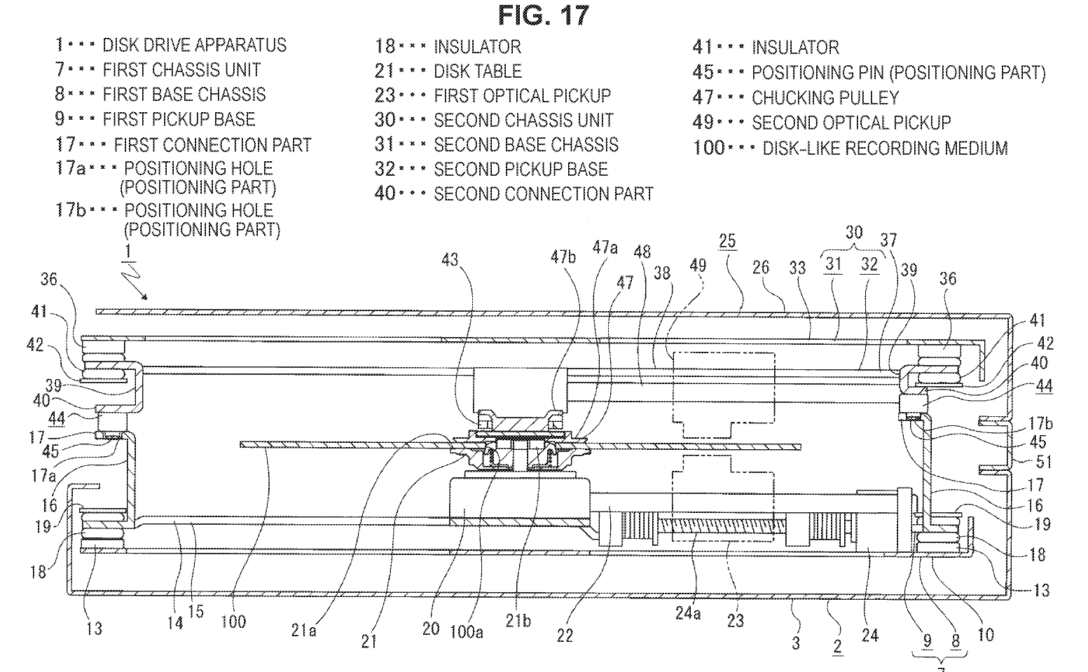

The cam sliders 52 and 52 are continuously moved rearward, the guided pins 12a and 12a of the first chassis unit 7 are slid to front ends of the front cam parts 53c and 53c of the first cam holes 53 and 53, respectively, and the guided pins 35a and 35a of the second chassis unit 30 are slid to front ends of the front cam parts 54c and 54c of the second cam holes 54 and 54, respectively (refer to FIGS. 16 and 17).

Accordingly, the first chassis unit 7 is moved further upward and also the second chassis unit 30 is moved further downward, and the disk table 21 and the chucking pulley 47 further approach to each other.

The guided pins 12a and 12a are slid to the front cam parts 53c and 53c, respectively, and the guided pins 35a and 35a are slid to the front cam parts 54c and 54c, respectively, whereby the second chassis unit 30 made into the state of being slightly inclined forward is made into a horizontal state.

When the guided pins 12a and 12a are slid to the front cam parts 53c and 53c, respectively, and the guided pins 35a and 35a are slid to the front cam parts 54c and 54c, respectively, the positioning pin 45 of the magnet cover 44 attached to the front second connection part 40 in the second pickup base 32 is inserted in the positioning hole 17a formed in the front first connection part 17 of the first pickup base 9.

At this time, also in a case where positions of the positioning pin 45 and the positioning hole 17a are slightly deviated in the horizontal surface, the taper part 45a whose diameter is made smaller than the other portion is slid to an opening edge of the positioning hole 17a, the first pickup base 9 and the second pickup base 32 are displaced to the first base chassis 8 and the second base chassis 31, respectively, and the positioning pin 45 is reliably inserted in the positioning hole 17a.

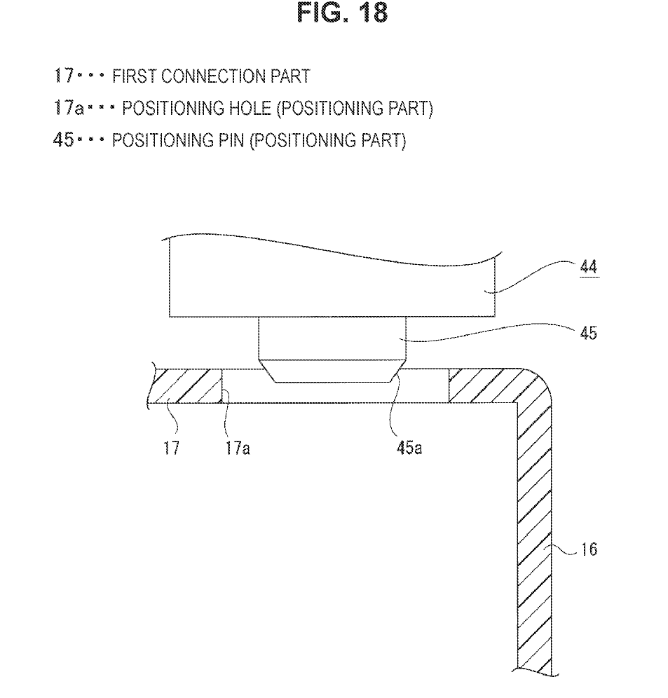

In addition, as described above, since the front positioning hole 17a is formed in the elongated shape that is long in the front/rear direction, the positioning pin 45 is smoothly inserted in the positioning hole 17a without interfering with the front opening edge and the rear opening edge of the positioning hole 17a when the positioning pin 45 is inserted in the positioning hole 17a while the second chassis unit 30 having made into the state of being slightly inclined forward is made into the horizontal state (refer to FIG. 18).

As described above, the positioning pin 45 of the magnet cover 44 attached to the rear second connection part 40 is inserted in the positioning hole 17b formed in the rear first connection part 17, and the positioning pin 45 of the magnet cover 44 attached to the front second connection part 40 is inserted in the positioning hole 17a formed in the front first connection part 17, whereby positioning of the first pickup base 9 and the second pickup base 32 is performed (refer to FIGS. 16 and 17).

In addition, in a state where positioning of the first pickup base 9 and the second pickup base 32 is performed, the rear first connection part 17 is attracted by the magnet 46 held by the magnet cover 44 attached to the rear second connection part 40, and the front first connection part 17 is attracted by the magnet 46 held by the magnet cover 44 attached to the front second connection part 40. Accordingly, the first pickup base 9 and the second pickup base 32 are connected to each other by the two magnets 46 and 46.

When the disk table 21 and the chucking pulley 47 approach to each other, a metal plate of the disk table 21 is attracted by a magnet provided at the chucking pulley 47 through an inner periphery of the disk-like recording medium 100. Accordingly, the inner periphery of the disk-like recording medium 100 is sandwiched by the table part 21a of the disk table 21 and the pulley body 47a of the chucking pulley 47, and thereby the disk-like recording medium 100 is chucked.

Note that in the disk drive apparatus 1, a magnet is provided at the disk table 21, a metal plate is provided at the chucking pulley 47 to be attracted by the magnet, and then chucking may be performed, or that the magnet is provided at both the disk table 21 and the chucking pulley 47, both magnets are attracted to each other, and then chucking may be performed.

When the disk-like recording medium 100 is chucked, rearward movement of the cam sliders 52 and 52 is stopped.

When the disk-like recording medium 100 is chucked, and the rearward movement of the cam sliders 52 and 52 is stopped, the disk table 21 is rotated by a drive force of the spindle motor 20, the disk table 21, the chucking pulley 47, and the disk-like recording medium 100 are integrally rotated, and also one of the first optical pickup 23 and the second optical pickup 49 or both thereof is/are moved in a radial direction of the disk-like recording medium 100, and recording or reproduction of an information signal to the disk-like recording medium 100 is performed.

In the disk drive apparatus 1, as described above, the first pickup base 9 is connected to the first base chassis 8 through the insulators 18, 18, . . . , and the second pickup base 32 is connected to the second base chassis 31 through the insulators 41, 41, . . . .

Accordingly, in a state where the first pickup base 9 and the second pickup base 32 are connected to each other by the two magnets 46 and 46, vibration is hard to be transmitted to the first pickup base 9 and the second pickup base 32 due to functions of the insulators 18, 18, . . . and the insulators 41, 41, . . . , and recording or reproduction of the information signal to the disk-like recording medium 100 can be successfully performed.

In addition, in the state where the first pickup base 9 and the second pickup base 32 are connected to each other by the two magnets 46 and 46, by performing position adjustment of the first optical pickup 23 and the second optical pickup 49, recording or reproduction of the information signal can be typically successfully performed at the time of recording and reproduction of the information signal to the disk-like recording medium 100.

When rotation of the disk-like recording medium 100 is stopped, and recording or reproduction of the information signal to the disk-like recording medium 100 is ended, the cam sliders 52 and 52 are moved forward by the drive mechanism, the guided pins 12a and 12a of the first chassis unit 7 are slid from the front ends of the front cam parts 53c and 53c to the rear ends of the rear cam parts 53a and 53a of the first cam holes 53 and 53, respectively, and also the guided pins 35a and 35a of the second chassis unit 30 are slid from the front ends of the front cam parts 54c and 54c to the rear ends of the rear cam parts 54a and 54a of the second cam holes 54 and 54, respectively. Accordingly, the first chassis unit 7 is moved downward and also the second chassis unit 30 is moved upward, the disk table 21 and the chucking pulley 47 are spaced aside from each other, and chucking to the disk-like recording medium 100 is released.

When chucking to the disk-like recording medium 100 is released, the disk-like recording medium 100 is held again by the disk holding mechanism supported by the center chassis 51 at the chucking position.

As described above, in the second cam holes 54 and 54, the length L2F in the front/rear direction of the front cam part 54c located at the rear side is made slightly longer than the length L1F in the front/rear direction of the front cam part 54c located at the front side.

Accordingly, when the cam sliders 52 and 52 are moved forward by the drive mechanism, and the guided pins 12a and 12a are slid from the front ends of the front cam parts 53c and 53c toward the rear ends of the rear cam parts 53a and 53a, respectively, in a half-way state, the rear guided pin 35a becomes the state of being engaged with the front cam part 54c, the front guided pin 35a becomes the state of being engaged with the inclined cam part 54b, and the second chassis unit 30 is made into a state of being inclined slightly in a rearward raised manner (refer to FIG. 13).

The second chassis unit 30 is made into the state of being inclined slightly in the rearward raised manner as described above, and thereby the positioning pin 45 of the front magnet cover 44 is pulled out from the positioning hole 17a formed in the front first connection part 17 in the arrangement plate 14.

Subsequently, the cam sliders 52 and 52 are moved forward, and the guided pins 12a and 12a are slid to the rear ends of the rear cam parts 53a and 53a, respectively, whereby further, the first chassis unit 7 is moved downward and also the second chassis unit 30 is moved upward, and the positioning pin 45 of the rear magnet cover 44 is pulled out from the positioning hole 17b formed in the rear first connection part 17 in the arrangement plate 14.

As described above, the second chassis unit 30 is inclined slightly in the rearward raised manner, and pullout of the front positioning pin 45 from the positioning hole 17a and pullout of the rear positioning pin 45 from the positioning hole 17b are sequentially performed, whereby release of connection of the front first connection part 17 and the front second connection part 40 by the front magnet 46 is performed in advance of release of connection of the rear first connection part 17 and the rear second connection part 40 by the rear magnet 46.

As described above, in the disk drive apparatus 1, sequentially performed are release of attraction of the magnet 46 held by the one magnet cover 44 on the one first connection part 17 and release of attraction of the magnet 46 held by the other magnet cover 44 on the other first connection part 17.

Accordingly, since the release of the attraction of the magnets 46 and 46 is not simultaneously performed, it may be possible to respectively release the attraction of the magnets 46 and 46 on the respective first connection parts 17 and 17 by means of a small force, reduction in size of the drive mechanism that moves the cam sliders 52 and 52, and improvement in durability of the drive mechanism are achieved because the small force is enough, and reduction in manufacturing cost and in size of the disk drive apparatus 1 can be achieved.

In addition, release of the attraction on the one first connection part 17 and release of the attraction on the other first connection part 17 are sequentially performed, whereby the other first connection part 17 serves as a support point, the second chassis unit 30 is inclined, and release of the attraction on the one first connection part 17 is performed.

Accordingly, since the principle of leverage is used, and release of the attraction on the one first connection part 17 is performed, a force desired for the release of the attraction of the magnet 46 becomes small, and further reduction in manufacturing cost and in size of the disk drive apparatus 1 due to reduction in size of the drive mechanism can be achieved.

The second chassis unit 30 is made into a horizontal state from a state of being inclined slightly in a rearward raised manner, and the first chassis unit 7 is located at the lower movable end, and the second chassis unit 30 is located at the upper movable end.

The disk-like recording medium 100 is conveyed in the discharge direction (forward) by the conveyance device, and is stored in the disk cartridge.

Note that although an example has been shown in the above where at the time of loading of the disk-like recording medium 100, first, the rear positioning pin 45 is inserted in the rear positioning hole 17b, and next, the front positioning pin 45 is inserted in the front positioning hole 17a, conversely, first, the front positioning pin 45 may be inserted in the front positioning hole 17a, and next, the rear positioning pin 45 may be inserted in the rear positioning hole 17b.

As described above, first, the front positioning pin 45 is made to be inserted in the front positioning hole 17a, whereby the positioning pin 45 is easily inserted in the positioning hole 17a since the front positioning hole 17a is formed in the elongate shape that is long in the front/rear direction, and thus positioning operation of the first pickup base 9 and the second pickup base 32 can be easily and reliably performed.

In addition, although the example has been shown in the above where at the time of ejection of the disk-like recording medium 100, first, the front positioning pin 45 is pulled out of the front positioning hole 17a, and next, the rear positioning pin 45 is pulled out of the rear positioning hole 17b, conversely, first, the rear positioning pin 45 may be pulled out of the rear positioning hole 17b, and next, the front positioning pin 45 may be pulled out of the front positioning hole 17a.

### CONCLUSION

As described above, in the disk drive apparatus 1, at the first pickup base 9 supported by the first base chassis 8 through the insulators 18, 18, . . . , and the second pickup base 32 supported by the second base chassis 31 through the insulators 41, 41, . . . , respectively formed are the positioning pins 45 and 45 and the positioning holes 17a and 17b for positioning both the first pickup base 9 and the second pickup base 32 at the time of connection, and the first pickup base 9 and the second pickup base 32 are connected to each other by magnetic forces of the magnets 46 and 46.

Consequently, the first pickup base 9 is made deformable to the first base chassis 8 in the range where the insulators 18, 18, . . . are elastically deformed, and the second pickup base 32 is made deformable to the second base chassis 31 in the range where the insulators 41, 41, . . . are elastically deformed. Accordingly, the positioning pins 45 and 45 are easily inserted in the positioning holes 17a and 17b at the time of positioning of the first pickup base 9 and the second pickup base 32, and additionally, the first pickup base 9 and the second pickup base 32 are easily connected to each other by the magnets 46 and 46, and a smooth operation state including positioning operation at the time of chucking to the disk-like recording medium 100 can be secured.

In addition, both the first chassis unit 7 and the second chassis unit 30 are moved in a thickness direction (vertical direction) of the disk-like recording medium 100, and the first pickup base 9 and the second pickup base 32 are connected to or separated from each other.

Accordingly, since in a total moving stroke of the first chassis unit 7 and the second chassis unit 30, the moving stroke is distributed into the first chassis unit 7 and the second chassis unit 30, it may become possible to minimize movement amounts of the first chassis unit 7 and the second chassis unit 30 in the thickness direction of the disk-like recording medium 100, respectively, and improvement in positioning accuracy of the first pickup base 9 and the second pickup base 32 can be achieved.

Furthermore, in the disk drive apparatus 1, the first chassis unit 7 and the second chassis unit 30 are simultaneously moved.

Accordingly, speed-up of operation in the disk drive apparatus 1 can be achieved.

In addition, in the disk drive apparatus 1, provided are the cam sliders 52 and 52 that are moved in a predetermined direction and move the first chassis unit 7 and the second chassis unit 30.

Accordingly, the first chassis unit 7 and the second chassis unit 30, which are separate members, are moved by the cam sliders 52 and 52, and simplification of a structure of the disk drive apparatus 1 can be achieved.

Furthermore, the guided pins 12a and 12a, and 35a and 35a that are slidably engaged with the first cam hole 53 and the second cam hole 54 of the cam slider 52 are provided at the first base chassis 8 and the second base chassis 31, respectively, the cam slider 52 is moved, and the first chassis unit 7 and the second chassis unit 30 are moved.

Consequently, the first pickup base 9 supported by the first base chassis 8 and the second pickup base 32 supported by the second base chassis 31 are moved along with operation of the first base chassis 8 and the second base chassis 31 by means of the cam slider 52. Accordingly, a mechanism for moving the first base chassis 8 and the second base chassis 31 is simple, and the smooth operation state including positioning operation at the time of chucking to the disk-like recording medium 100 can be secured after securing simplification of the mechanism in the disk drive apparatus 1.

Furthermore, the positioning holes 17a and 17b and the positioning pins 45 and 45 are used as the positioning parts for performing positioning of the first pickup base 9 and the second pickup base 32.

Accordingly, configurations of the positioning parts are simple, and the smooth operation state including positioning operation at the time of chucking to the disk-like recording medium 100 can be secured after securing simplification of a structure.

Note that although an example has been shown in the above where the positioning holes 17a and 17b are formed in the first connection parts 17 and 17 of the first pickup base 9, the magnets 46 and 46 are held at the second connection parts 40 and 40 of the second pickup base 32, and where the magnet covers 44 and 44 that have the positioning pins 45 and 45 are attached, conversely, the magnet covers 44 and 44 may be attached to the first connection parts 17 and 17 of the first pickup base 9, and positioning holes may be formed in the second connection parts 40 and 40 of the second pickup base 32.

In addition, although an example has been shown in the above where the elongated positioning hole 17a is formed in the front first connection part 17, conversely, an elongated positioning hole may be formed in the rear first connection part 17.

It should be understood by those skilled in the art that various modifications, combinations, sub-combinations and alterations may occur depending on design requirements and other factors insofar as they are within the scope of the appended Claims or the Equivalents Thereof.

[Present Technology]

Additionally, the present technology may also be configured as below.

(1) A disk drive apparatus including:

a first chassis unit that has a first base chassis and a first pickup base supported by the first base chassis through an elastically deformable insulator; and

a second chassis unit that has a second base chassis and a second pickup base supported by the second base chassis through an elastically deformable insulator,

wherein, at the first pickup base, arranged are a disk table on which a disk-like recording medium is loaded and a first optical pickup that performs recording or reproduction of an information signal to the disk-like recording medium,

wherein, at the second pickup base, arranged are a chucking pulley that holds the disk-like recording medium by sandwiching the disk-like recording medium together with the disk table and a second optical pickup that performs recording or reproduction of an information signal to the disk-like recording medium,

wherein at least one of the first chassis unit and the second chassis unit is moved in a thickness direction of the disk-like recording medium, and the first pickup base and the second pickup base are connected to or separated from each other,

wherein positioning parts for performing positioning of the first pickup base and the second pickup base at a time of connection are provided at the first pickup base and the second pickup base, respectively, and

wherein the first pickup base and the second pickup base are connected to each other by magnetic forces of magnets.

(2) The disk drive apparatus according to (1), wherein the first chassis unit and the second chassis unit are moved in the thickness direction of the disk-like recording medium, and the first pickup base and the second pickup base are connected to or separated from each other.
(3) The disk drive apparatus according to (2), wherein the first chassis unit and the second chassis unit are simultaneously moved.
(4) The disk drive apparatus according to (3), wherein provided are cam sliders that are moved in a predetermined direction and move the first chassis unit and the second chassis unit.
(5) The disk drive apparatus according to (4),

wherein cam holes are formed in the cam sliders,

wherein guided pins slidably engaged with the cam holes are provided at the first base chassis and the second base chassis, respectively, and

wherein, when the cam sliders are moved in the predetermined direction, the guided pins of the first base chassis and the second base chassis are slid to the cam holes, and the first chassis unit and the second chassis unit are moved.

(6) The disk drive apparatus according to (1), wherein one of the positioning parts of the first pickup base and the positioning parts of the second pickup base is provided as positioning pins, and the other one of the positioning parts of the first pickup base and the positioning parts of the second pickup base is formed as positioning holes.
(7) The disk drive apparatus according to (6),

wherein a pair of first connection parts are provided at the first pickup base,

wherein a pair of second connection parts connected to the pair of first connection parts, respectively, are provided at the second pickup base,

wherein the positioning holes are formed in the pair of first connection parts or the pair of second connection parts, respectively, and

wherein one of the positioning holes is formed in an elongated shape that extends in a direction where the pair of first connection parts or the pair of second connection parts are aligned.

(8) The disk drive apparatus according to (7),

wherein the elongated positioning hole is formed in one of the first connection part or one of the second connection part, and

wherein connection of the connection part in which the elongated positioning hole has been formed with the other connection part is performed in advance of connection of the connection part in which the elongated positioning hole has not been formed with the other connection part.

(9) The disk drive apparatus according to (7) or (8), wherein separation of one of the first connection parts from one of the second connection parts is performed in advance of separation of the other one of the first connection parts from the other one of the second connection parts.

What is claimed is:

1. A disk drive apparatus comprising:
a first chassis unit that has a first base chassis and a first pickup base supported by the first base chassis through an elastically deformable insulator; and
a second chassis unit that has a second base chassis and a second pickup base supported by the second base chassis through an elastically deformable insulator,
wherein, at the first pickup base, arranged are a disk table on which a disk-like recording medium is loaded and a first optical pickup that performs recording or reproduction of an information signal to the disk-like recording medium,
wherein, at the second pickup base, arranged are a chucking pulley that holds the disk-like recording medium by sandwiching the disk-like recording medium together with the disk table and a second optical pickup that performs recording or reproduction of an information signal to the disk-like recording medium,
wherein at least one of the first chassis unit and the second chassis unit is moved in a thickness direction of the disk-like recording medium, and the first pickup base and the second pickup base are connected to or separated from each other,
wherein positioning parts for performing positioning of the first pickup base and the second pickup base at a time of connection are provided at the first pickup base and the second pickup base, respectively, and
wherein the first pickup base and the second pickup base are connected to each other by magnetic forces of magnets.

2. The disk drive apparatus according to claim 1, wherein the first chassis unit and the second chassis unit are moved in the thickness direction of the disk-like recording medium, and the first pickup base and the second pickup base are connected to or separated from each other.

3. The disk drive apparatus according to claim 2, wherein the first chassis unit and the second chassis unit are simultaneously moved.

4. The disk drive apparatus according to claim 3, wherein provided are cam sliders that are moved in a predetermined direction and move the first chassis unit and the second chassis unit.

5. The disk drive apparatus according to claim 4,
wherein cam holes are formed in the cam sliders,
wherein guided pins slidably engaged with the cam holes are provided at the first base chassis and the second base chassis, respectively, and
wherein, when the cam sliders are moved in the predetermined direction, the guided pins of the first base chassis and the second base chassis are slid to the cam holes, and the first chassis unit and the second chassis unit are moved.

6. The disk drive apparatus according to claim 1, wherein one of the positioning parts of the first pickup base and the positioning parts of the second pickup base is provided as positioning pins, and the other one of the positioning parts of the first pickup base and the positioning parts of the second pickup base is formed as positioning holes.

7. The disk drive apparatus according to claim 6,
wherein a pair of first connection parts are provided at the first pickup base,
wherein a pair of second connection parts connected to the pair of first connection parts, respectively, are provided at the second pickup base,
wherein the positioning holes are formed in the pair of first connection parts or the pair of second connection parts, respectively, and
wherein one of the positioning holes is formed in an elongated shape that extends in a direction where the pair of first connection parts or the pair of second connection parts are aligned.

8. The disk drive apparatus according to claim 7,
wherein the elongated positioning hole is formed in one of the first connection part or one of the second connection part, and
wherein connection of the connection part in which the elongated positioning hole has been formed with the other connection part is performed in advance of connection of the connection part in which the elongated positioning hole has not been formed with the other connection part.

9. The disk drive apparatus according to claim 7, wherein separation of one of the first connection parts from one of the second connection parts is performed in advance of separation of the other one of the first connection parts from the other one of the second connection parts.
